(19) United States
(12) Patent Application Publication
(10) Pub. No.: US 2013/0076005 A1
(43) Pub. Date: Mar. 28, 2013

(54) DISASTER EVACUATION CART

(71) Applicant: Mark J. McDade, El Cajon, CA (US)

(72) Inventor: Mark J. McDade, El Cajon, CA (US)

(21) Appl. No.: 13/623,664

(22) Filed: Sep. 20, 2012

Related U.S. Application Data
(60) Provisional application No. 61/537,782, filed on Sep. 22, 2011.

(51) Int. Cl. B62B 1/20; B23P 11/00; B62B 5/04

(52) U.S. Cl. 280/418.1; 280/47.26; 280/657; 29/428

(57) ABSTRACT

The present invention is directed to a Disaster Evacuation Cart that can be handled by one or two people or may be towed by a bicycle, off road motorcycle or an all-terrain vehicle into and out of areas of difficult passage, may be converted into a stretcher carrier and may be stored in an upright position. Handles on the lower surface support the device in the upright position and can be used when transporting in difficult areas. The device is equipped with hand brakes for absolute control. The sides and back will have a load bearing fabric material covering that accommodates MOLLE gear and accessories which may include, but are not limited to storage bags, pouches, and utility items like knives, machetes, hatchets and shovels along with a variety of defensive items like mace and fire arms. Additional accessories will include extension handle bars, a vehicle tow bar and fabric stretcher material. The Disaster Evacuation Cart will have a large central storage cavity with a smaller storage cavity below for heavy objects like water or ammunition.

### FIELD OF THE INVENTION

This application applies to carts that can be used as an emergency storage container or be transported by a single individual b hand or with a bicycle or a motorized ehicle to be used in emergency situations to transport supplies, or as a sleeping platform and stretcher to transport an injured person.

### BACKGROUND OF THE INVENTION

The hand cart is the oldest method of transporting items and has been used since biblical times and has gone through many variations in the design and applications. There is a growing need for a multipurpose cart that can be used for storing disaster preparedness supplies and be for transport during emergency situations. In just the past few years there have been a great number of disasters where the passage of vehicles have been impaired, and supplies needed to be taken in and injured people needed to be taken out. In these cases the rubble has often made the roads impassable and the time required to get people out could mean the difference between life and death. Other applications may occur where supplies needed to be taken in and injured people needed to he taken out of wild life areas where there are no roads available. This often occurs during wildfires when the time involved is extremely critical. Too often this transport has only been by the means of carrying supplies in and people out by hand.

This application details a unique multipurpose Disaster Evacuation Cart that can be handled by one or two people or may be towed by a bicycle, an off road motorcycle or an all-terrain vehicle into and out of areas of difficult passage. The Disaster Evacuation Cart can be moved forward or backward in an inclined position or lay be stored in an upright position. It is equipped with hand brakes for absolute control when handled by a single person. Handles or legs on the lower surface support the device in the upright position and can be used when transporting in difficult areas like up or down stairs. The sides and back will have a load bearing fabric material covering the framework that accommodates modular lightweight load-carrying equipment (MOLLE) gear and accessories. These accessories may include, but are not limited to storage bags, pouches, and utility items like knives, machetes, hatchets and shovels, along with a variety of defensive items like mace and fire arms. Additional accessories will include extension handle bars, a vehicle tow bar, and fabric stretcher material. The Disaster Evacuation Cart will have a large central storage cavity with a smaller storage cavity below for heavy objects like water or ammunition. Using the disk or caliper breaking system, a variety of sizes and shapes of tires can be used on the Disaster Evacuation Cart.

An optional anti-ballistic protection will be available beneath the back panel load bearing fabric consisting of materials that are fabricated using not only Aramid fibers and KEVLAR® from DuPont, but also polyethylene fibers and GOLD SHIELD®, which is as KEVLAR® based material, and SPECTRA SHIELD®, which is polyethylene based material, both available commercially from Honeywell. GOLD SHIELD® and SPECTRA SHIELD® are high strength synthetic fibers impregnated in partially cured resin for use in anti-ballistic material. This protective material will allow a person to crouch down behind the Disaster Evacuation Cart in the upright position for bullet-resistant protection if necessary. Bullet-resistant materials, also called ballistic materials or, equivalently, anti-ballistic materials, are usually rigid, but may be supple. They may be complex, such as KEVLAR®, LEXAN®, and carbon fiber composite materials, or they may be basic and simple, such as steel or titanium and all will be covered within the scope of this application. Bullet resistant materials are often used in law enforcement and military applications, to protect personnel from death or serious injuries and may be incorporated in the design of this application to he used in special purposes.

Numerous innovations for the Disaster Evacuation Cart have been provided in the prior art that are described as follows. Even though these innovations may be suitable for the specific individual purposes to which they address, they differ from the present design as hereinafter contrasted. The following. is a summary of those prior art patents most relevant to this application at hand, as well as a description outlining the difference between the features of the Disaster Evacuation Cart and the prior art.

U.S. Pat. No. 6,824,150 of Jason Simione describes a cart for the transportation of personnel and equipment in a fire or other hazardous environment The cart is constructed out of fire protective material and designed to float. There are wheels on the bottom surface, which are placed and designed to be able to be operative over very uneven surfaces. The structure also has the ability to store fire equipment and in addition on the top surface a fully dressed firefighter with a Scott Air Pack. The cart has handles, which can be adjusted so as to he folded into different locked positions based on the particular usage conditions.

This patent describes a large cart for the transportation of personnel and equipment in a tire or other hazardous environment but has not been designed to be towed by a vehicle into remote areas and has also not been designed for private usage for people to store disaster evacuation materials in their homes.

U.S. Pat. No. 7,188,846 of Pericles Ponciano Deavila describes a mobile safety compliance apparatus comprising a shell with a plurality of open compartments closed by doors, a self-contained water supply system and a waste water collection system. The water supply system provides drinking water, tepid hand washing water, and water for a stowable eyewash hingedly attached to the shell. The waste water collection system collects water from the eyewash and a sink mounted in a recessed area of the shell. Doors are removable and have features to facilitate alternative uses such as a stretcher or a freestanding table. A stowable seat and table are hingedly attached to the shell. The apparatus includes an electrical system with battery backup for powering lights, water heating and refrigeration devices, and electronic communication equipment that may be mounted on the shell. The apparatus includes wheels to facilitate its movement and anchor points to secure it to the ground

This patent describes a mobile safety compliance apparatus that has a plurality of open compartments but would be awkward to transport into remote areas and has not been designed to be towed by a vehicle into these areas. It has also not been designed for personal usage to store disaster evacuation materials.

U.S. Pat. No. 7,392,994 of Charles W. Darling, III describes a mission adaptable multi-purpose, collapsible portable cart/utility table, for use in emergency response and disaster situations, camping, hunting and other outdoors activities, which carries medical rescue carts, canoes, small boats, game, or hauled cargo by hand. It transports one or more cargo bins over long, rough terrain and each bin can include one or more cabinet drawers therein, wherein upon tilting of a cargo bin from a horizontal transport position to a substantially vertical position the cargo bin serves as a supply cabinet. Each bin is openable to expose the supply drawers for use.

This patent describes a mission adaptable multi-purpose, collapsible portable cart/utility table, for use in emergency response and disaster situations. This device with four wheels has been designed for heavy duty usage and could not be easily be taken up stairs or be used for personal usage to store disaster evacuation materials in small homes or apartments.

U.S. Pat. No. 7,766,365 of Charles W. Darling, III describes a mission adaptable multi-purpose, collapsible portable cart/utility table, for use in emergency response and disaster situations, camping, hunting and other outdoors activities, which carries medical rescue carts, canoes, small boats, game, or hauled cargo by hand. The portable cart/utility table can be converted to various uses and the portable cart/utility table can be folded down and transported within a wheeled bin, backpack, hand carried bag, canoe or boat. It transports injured persons or cargo over long, rough terrain and it can broken down into a carrying position, by hand or by back. The objects being carried can be held by clamps, by fasteners, or through the use of insertions with longitudinally extending channels. An optional pivotable kickstand and/or tie rods can stabilize the cart in a position of rest. The portable cart/utility table can also be the basis of a reconfigurable, modular, expandable medical critical care point of need field installation system deployable by land, sea, and air to reach very remote and rugged regions.

This patent describes a mission adaptable multi-purpose, collapsible portable cart/utility table, for use in emergency response and disaster situations. This device has been designed primarily for medical use in the field with other additional applications but has not been designed to be towed into remote areas by small vehicles or kept by people to store disaster evacuation materials in small homes or apartments.

U.S. Pat. No. 7,775,530 of Charles W. Darling, III describes an integrated multi-purpose deployment field system that enables a user to build a plurality of field pieces of equipment for field use in recreation, rescue, medicine, military operations, disaster relief and non-motorized cargo hauling. The system includes assembling the field equipment from a plurality of interchangeable T-shaped load support components. Each load support component has a generally horizontal load support member which is configured to support a particular type of load in the field, and a generally vertically extending support strut which extends from a midsection of the horizontal load support member. A load support attachment, such as a wheel axle or a cross brace, engages with each horizontal load support member, and joins the horizontal support members so that the T-shaped load support components, vertical struts, and load support attachments form a load bearing structure when assembled.

This patent describes an integrated multi-purpose deployment field system that enables a user to build a plurality of field pieces of equipment for field use in recreation, rescue, medicine, military operations, disaster relief and non-motorized cargo hauling. This device has not been designed to he towed into remote areas by small vehicles or kept by people to store disaster evacuation materials in small homes or apartments.

None of these previous efforts, however, provides the benefits attendant with the Disaster Evacuation Cart. The present design achieves its intended purposes, objects and advantages over the prior art devices through a new, useful and unobvious combination of method steps and component elements, with the use of a minimum number of functioning parts, at a reasonable cost to manufacture, and by employing readily available materials.

In this respect, before explaining at least one embodiment of the Disaster Evacuation Cart in detail it is to be understood that the design is not limited in its application to the details of construction and to the arrangement of the components set forth in the following description or illustrated in the drawings. The Disaster Evacuation Cart is capable of other embodiments and of being practiced and carried out in various ways. In addition, it is to be understood that the phraseology and terminology employed herein are for the purpose of description and should not be regarded as limiting. As such, those skilled in the art will appreciate that the conception upon which this disclosure is based may readily be utilized as a basis for designing of other structures, methods and systems for carrying out the several purposes of the present design. It is important, therefore, that the claims be regarded as including such equivalent construction insofar as they do not depart from the spirit and scope of the present application.

### SUMMARY OF THE INVENTION

The principal advantage of the Disaster Evacuation Cart is to create a complete integrated low tech mobile solution system to disaster preparedness.

Another advantage of the Disaster Evacuation Cart is that it can be conveniently stored and is easily transportable be used in a variety of emergency situations

Another advantage of the Disaster Evacuation Cart is that it can be quickly changed to be towed by a vehicle.

Another advantage of the Disaster Evacuation Cart is that by extending the handle bars it can be converted to a stretcher carrier.

Another advantage of the Disaster Evacuation Cart is that the tires can be easily removed to minimize the storage room required.

Another advantage of the Disaster Evacuation Cart is that the tires are not air filled but are a solid material.

Another advantage of the Disaster Evacuation Cart is that it will have a load bearing fabric material covering the framework that accommodates modular lightweight load-carrying equipment also known as MOLLE gear and accessories.

Another advantage of the Disaster Evacuation Cart is that it will have the option of incorporating bullet resistant materials that are often used in law enforcement and military applications on various surfaces.

Yet another advantage of the Disaster Evacuation Cart is that it will have a separate handle for handling the device in the upright position.

And still another advantage of the Disaster Evacuation Cart is that it will have disk or caliper braking capability.

Another advantage of the Disaster Evacuation Cart is that using the disk breaking system a variety of sizes and shapes of tires can be quickly changed and used for rough terrain.

A further advantage is the Disaster Evacuation Cart will have the option of either a fixed straight axle, or a dropped axle of a spring loaded axle suspension system.

In this respect, before explaining at least one embodiment of the Disaster Evacuation Cart in detail it is to be understood that the design is not limited in its application to the details of construction and to the arrangement of the components set forth in the following description or illustrated in the drawings. The Disaster Evacuation Cart is capable of other embodiments and of being practiced and carried out in various ways. In addition, it is to be understood that the phraseology and terminology employed herein are for the purpose of description and should not be regarded as limiting.

The Disaster Evacuation Cart will consist of a box or tubular type of frame work consisting of two side panels, a back panel, a bottom panel and an intermittent shelf panel composed of wood, composition material or metal. The side and back panels have the option of having a polarity of holes for the purpose of reducing the overall weight of the device. These holes are often called lightning holes. Two handles are attached to the lower surface of the bottom panel for the purpose of supporting the unit in the upright position and for man handling the unit when necessary.

D-rings are intermittently located on the edges of the side panels for a means of tying down objects. The side and back panels will have a load bearing fabric material covering that accommodates MOLLE gear and accessories. The back panel will also have the option of having a bullet resistant material that is often used in law enforcement and military applications. The wheels which have solid material in the tires can be quickly removed by removing a single bolt or pulling the quick-disconnect pin in the axle. Brakes are supplied by the means of a disk break or caliper break system with conventional bicycle grips and hand break actuator. Using the disk breaking system a variety of sizes and shapes of tires can be quickly changed and used for rough terrain

The handle located at the top between the two sides will be used for maneuvering in the upright position. The handle bars have four pieces on each side consisting of two stationary handle bars permanently attached to side panels of the frame of the unit with two bottom and two top extension bars and two secondary extension handle bars incorporating a conventional bicycle grips and hand break actuators. The extension bars can be adjusted by relocating the quick-disconnect pins to increase the leverage when moving the Disaster Evacuation Cart in the inclined position or when the unit is converted to a stretcher carrier. A tow bar has been designed to couple with the stationary handle bars to supply a means of towing behind a vehicle.

A variety of axels can be provided from a straight axle going through the frame work to a dropped axle that goes below the bottom panel to one of two or more spring loaded side mounting axle supporting mechanisms.

The foregoing has outlined rather broadly the more pertinent and important features of the present Disaster Evacuation Cart in order that the detailed description of the application that follows may be better understood so that the present contribution to the art may be more fully appreciated. Additional features of the design will be described hereinafter which form the subject of the claims of this disclosure. It should be appreciated by those skilled in the art that the conception and the disclosed specific embodiments may be readily utilized as a basis for modifying or designing other structures and methods for carrying out the same purposes of this application. It should also be realized by those skilled in the art that such equivalent constructions and methods do not depart from the spirit and scope of this application as set forth in the appended claims.

### BRIEF DESCRIPTION OF THE DRAWINGS

The accompanying drawings, which are incorporated in and form a part of this specification, illustrate embodiments of the Disaster Evacuation Cart and together with the description, serve to explain the principles of this application.

FIG. 1 depicts a partially exploded perspective view of the Disaster Evacuation Cart assembly in the inclined position.

FIG. 2 depicts three variations of handle bar and wheel quick disconnect pins.

FIG. 3 depicts a partially exploded perspective view of the Disaster Evacuation Cart assembly in the upright position displaying the preferred embodiment of the disk brake units with the wheels and cart handle exploded away.

FIG. 4 depicts a detail perspective view of the lower section of the Disaster Evacuation Cart displaying the first alternate embodiment of the caliper brake units.

FIG. 5 depicts a perspective view of the rear of the Disaster Evacuation Cart in the uptight position.

FIG. 6 depicts a plan view of the first alternate embodiment of the spring loaded axle suspension system.

FIG. 7 depicts a perspective view of the Disaster Evacuation Cart assembly in the inclined position equipped to be used as a stretcher.

FIG. 8 depicts a rear view of the lower section of the Disaster Evacuation Cart using a dropped axle configuration.

FIG. 9 depicts a view of the axle cushioning support member.

FIG. 10 depicts a perspective view of the preferred embodiment of the spring loaded axle support assembly used on the Disaster Evacuation Cart.

FIG. 11 depicts a perspective view of the internal mechanism of the preferred embodiment of the axle support assembly used on the Disaster Evacuation Cart.

FIG. 12 depicts a view of the position and location where the preferred embodiment of the axle support assembly is located on the sides of the Disaster Evacuation Cart.

For a fuller understanding of the nature and advantages of the Disaster Evacuation Cart, reference should be had to the following detailed description taken in conjunction with the accompanying drawings which are incorporated in and form a part of this specification, illustrate embodiments of the design and together with the description, serve to explain the principles of this application.

### DETAILED DESCRIPTION OF THE PREFERRED EMBODIMENTS

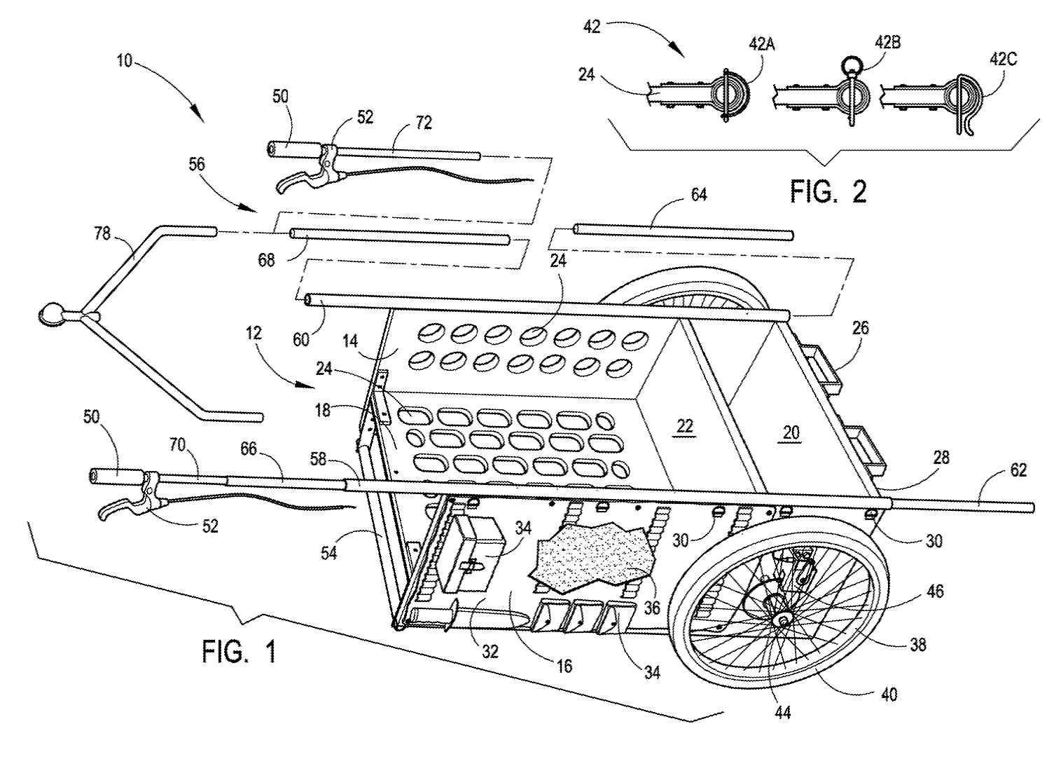

Referring now to the drawings, wherein similar parts of the Disaster Evacuation Cart 10 are identified by like reference numerals, there is seen in FIG. 1 a partially exploded perspective view of the Disaster Evacuation Cart 10 assembly in the inclined position consisting of a box or tubular type of frame work 12 composed of two side panels 14 and 16, a hack panel 18, a bottom panel 20 and an intermittent shelf panel 22 constructed of wood, composition material or metal. The side panels 14 and 16 and back panel 18 have the option of having a polarity of lightening holes 24 for the purpose of reducing the overall weight of the device. One or more handle grips 26 are attached to the lower surface 28 of the bottom panel 20 for the purpose of supporting the unit in the upright position and for man handling the unit when necessary.

D-rings 30 are intermittently located on the edges of the side panels 14 and 16 for a means of tying down objects. The side panels 14 and 16 and back panel 18 will have a load bearing fabric material 32 covering that accommodates modular lightweight load-carrying equipment also known as MOLLE gear and accessories 34. The back panel 18 will also have the option of having a bullet resistant material 36 that is often used in law enforcement and military applications. The wheels 38 which may have solid material in the tires 40 or be conventional pneumatic tires, can be quickly removed by pulling the quick-disconnect pins 42 (as shown in FIG. 2) shown in the straight axle 44A. Brakes are supplied by the means of a disk break system 46, or caliper break system 48 (as shown in FIG. 4) with conventional bicycle grips 50 and hand break actuator 52.

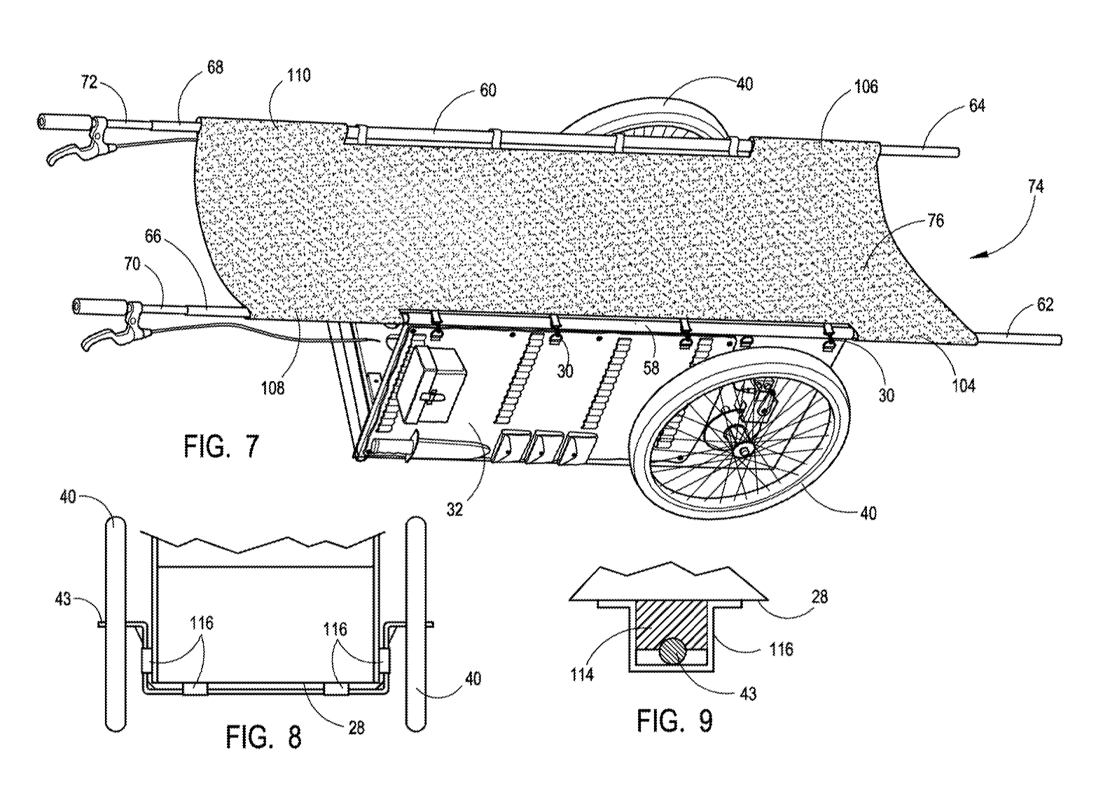

An additional cart handle 54 (or multiple handles) is located at the top between the two side panels 14 and 16 that will be used for maneuvering the unit in the upright position. The handle bars 56 consisting of four pieces on each side incorporating the stationary handle bars 58 and 60 permanently or semi-permanently attached to side panels 14 and 16 of the frame of the unit 12 with bottom extension bars 62 and 64 and top extension bars 66 and 68 along with secondary extension handle bars 70 and 72 having conventional bicycle grips 50 and hand break actuators. The extension bars can be adjusted by relocating the quick-disconnect pins 42 to increase the leverage when moving the Disaster Evacuation Cart 10 in the inclined position or when the unit is converted to a stretcher assembly 74 (as shown in FIG. 7) using the stretcher fabric 76. A tow bar 78 has been designed to couple with the top extension bar 66 and 68 to supply a means of towing behind a vehicle.

FIG. 2 depicts three variations of handle bar and wheel quick disconnect pins 42 with conventional quick disconnect pin 42A with a swing over locking bar, a ball detent quick disconnect pin 42B and a mouse clip disconnect pin 42C.

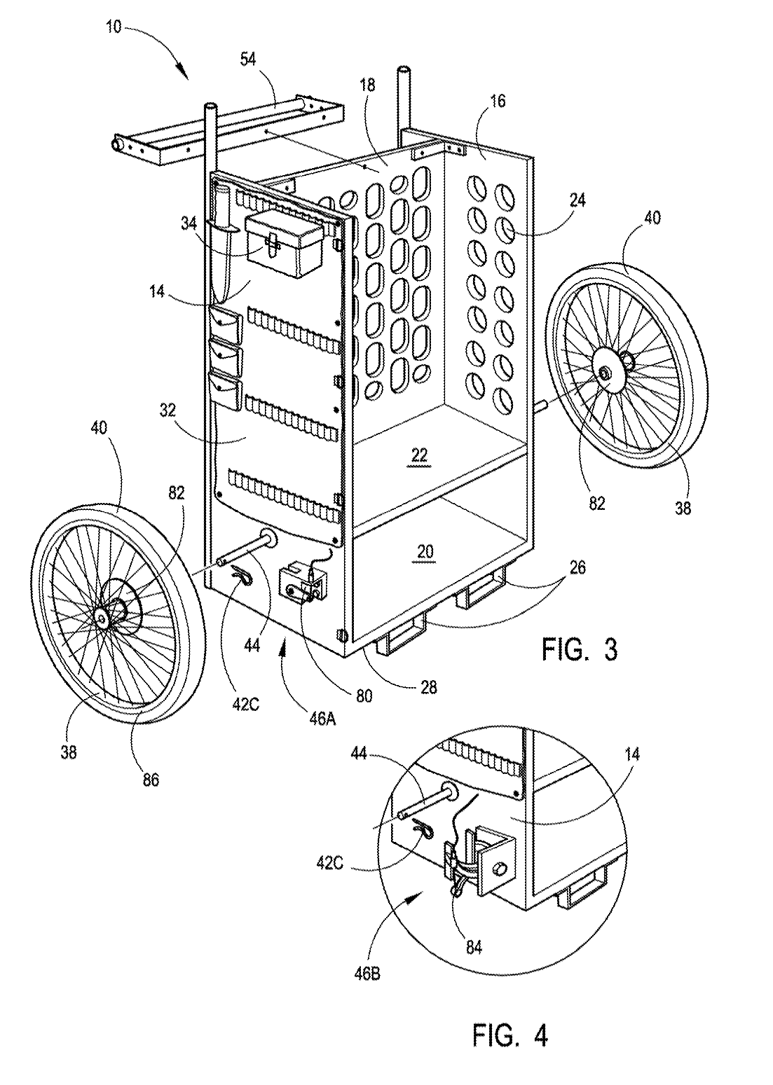

FIG. 3 depicts a partially exploded perspective view of the Disaster Evacuation Cart 10 assembly in the upright position displaying the preferred embodiment of the disk brake system 46A incorporating the brake caliper 80 and the break disk 82 with the wheels 38 and cart handle 54 exploded away. The two handles 26 are shown below the bottom panel lower surface 28 in the position where they will be resting on the ground.

FIG. 4 depicts a detail perspective view of the lower section of the Disaster Evacuation Cart 10 displaying the first alternate embodiment of the caliper brake system 46B using the conventional bicycle calipers 84 that grip the wheel rim 86.

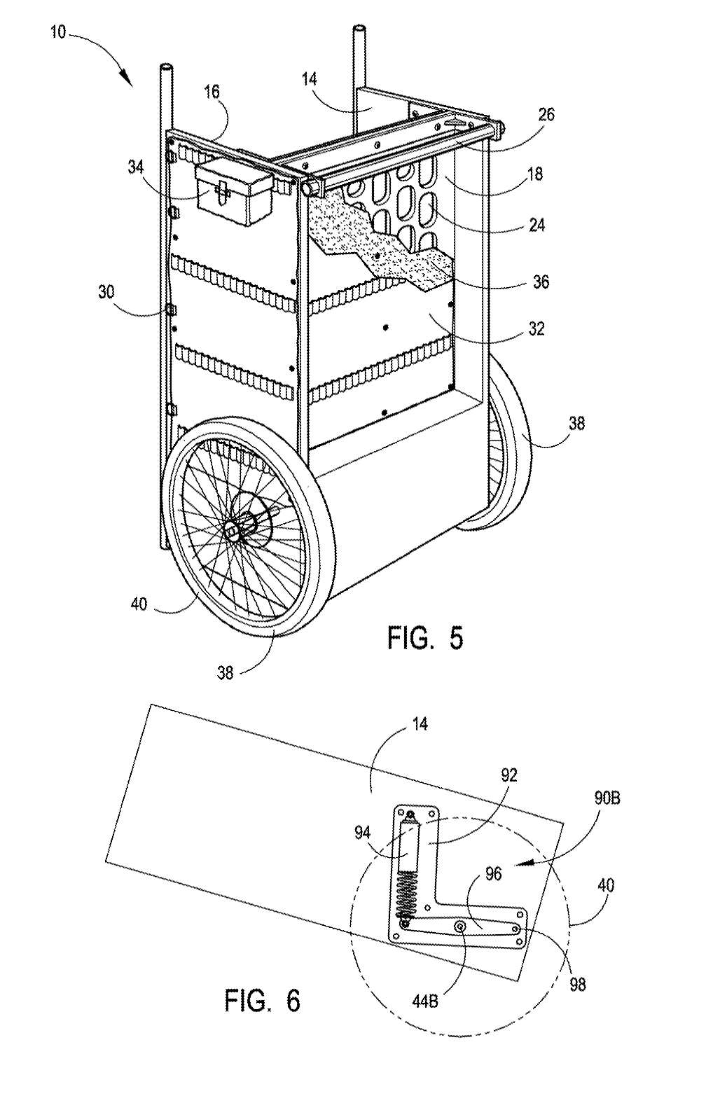

FIG. 5 depicts a perspective view of the rear of the Disaster Evacuation Cart 10 in the upright position illustrating the layering of the load bearing fabric material 32 that accommodates MOLLE gear and accessories, such as pouch 34 shown mounted over the bullet resistant material 36 on the back panel 24. The effect of the bullet resistant material 36 stopping a projectile is achieved by the means of the bullet resistant material 36 being able to move away from the back panel 18 and flexibly absorb the shock force. It has been designed to protect the person crouching down behind the unit.

FIG. 6 depicts a plan view of the first alternate embodiment of the spring loaded axle suspension system 90B with the back mounting plate 92. A spring assisted shock absorber 94 is attached to the mounting plate 92 and a pivot arm 96 that pivots on pivot pin 98 with the stub axle 44B in the center. These are mounted on both sides of the Disaster Evacuation Cart 10 giving a cushioning action to the cart.

FIG. 7 depicts a perspective view of the Disaster Evacuation Cart 10 unit in the inclined position equipped to be used as the stretcher assembly 74 where the two bottom extension bars 62 and 64 are positioned to support the lower cuffed ends 104 and 106 of the stretcher fabric 76 and the top extension bars 66 and 68 are positioned to support the upper cuffed ends 108 and 110. When the extension bars 62 and 64, and 66 and 68 are in position they will be locked in place by the means of the quick-disconnect pins 42 (as shown in FIG. 2).

FIG. 8 depicts a rear view of the lower section of the Disaster Evacuation Cart 10 using a dropped axle 43 configuration where the axle drops below the bottom panel lower surface 28.

FIG. 9 depicts a view of the axle cushioning support member 114 with a rubber insert 116 as a shock absorber for the axle 43. A variety of axels 44 can be provided from a straight axle 44A going through the frame work 14 to a dropped axle 43 that goes below the bottom panel 20 to one of two spring loaded side mounting axle supporting mechanisms 90A and 90B.

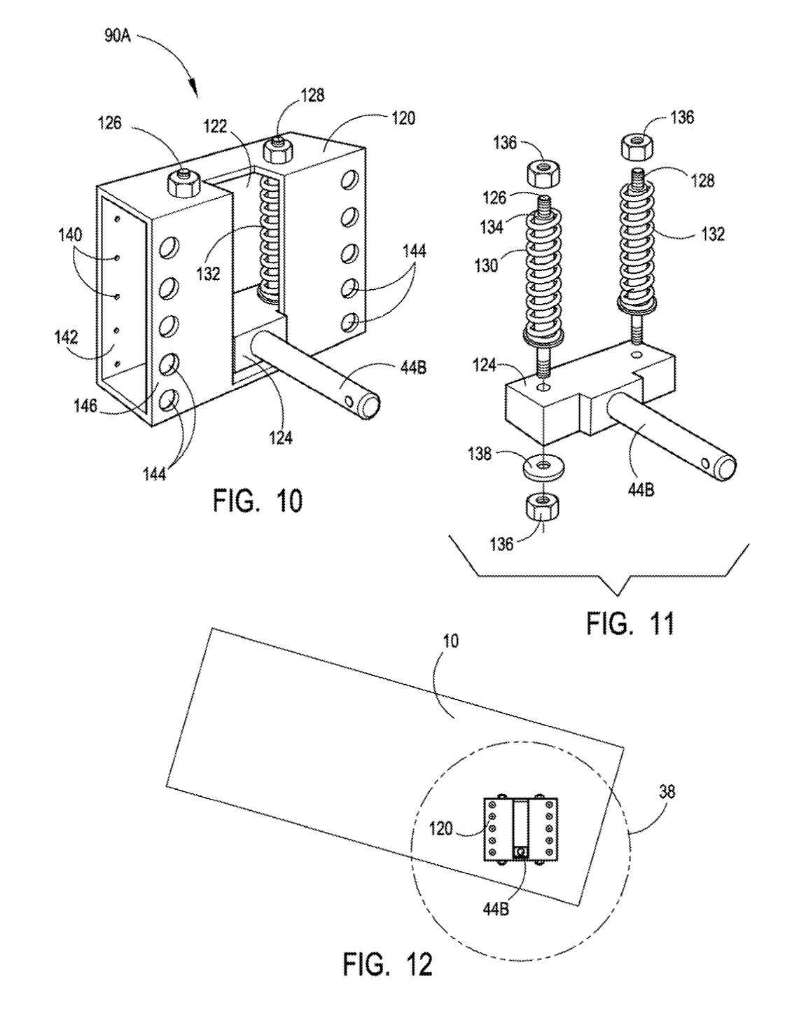

FIG. 10 depicts a perspective view of the preferred embodiment of the axle support assembly 90A used on the Disaster Evacuation Cart 10 where a rectangular tubular member 120 has a machined slot 122 on one side where the axle mounting block 124 extends to support the stub axle 44B and is able to move up and down supported by the means of two shafts 126 and 128 extending through springs 130 and 132 which have rubber cushioning inserts 134 and are held in place by nuts 136 on both ends. A rubber cushioning strip or washer 138 is located below the sliding trunion axle mounting block 123 on each of the shafts 126 and 128. A plurality of mounting holes 140 are on the back wall 142 on each side of the rectangular tubular member 120 with a matching plurality of clearance holes 144 on the front surface 146 for mounting access and a reduction of the weight.

FIG. 11 depicts a perspective view of the internal mechanism of the preferred embodiment of the spring loaded axle suspension system 90A used on the Disaster Evacuation Cart 10.

FIG. 12 depicts a view of the angular position and location where the preferred embodiment of the spring loaded axle suspension system 90A located on the sides of the Disaster Evacuation Cart 10.

The Disaster Evacuation Cart 10 shown in the drawings and described in detail herein disclose arrangements of elements of particular construction and configuration for illustrating preferred embodiments of structure and method of operation of the present application. It is to be understood, however, that elements of different construction and configuration and other arrangements thereof, other than those illustrated and described may be employed for providing a Disaster Evacuation Cart 10 in accordance with the spirit of this disclosure, and such changes, alternations and modifications as would occur to those skilled in the art are considered to be within the scope of this design as broadly defined in the appended claims.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

I claim:

1. A disaster evacuation cart comprising:
a) a box formed from a tubular framework having two side panels, a back panel, a bottom panel and one or more shelf panels attached thereto;
b) wheels removably and rotatably attached to an axle, with said axle attached to suspension system;
c) extension handles, extendable out from the front and rear of the disaster evacuation cart, having means for securing said extension handles in a variety of both forward outward and rearward outward length positions; and
d) a braking system including hand actuated braking levers located removably on said extension handles.

2. The disaster evacuation cart according to claim 1, wherein said one or more shelf panels are position adjustable.

3. The disaster evacuation cart according to claim 1, wherein said two side panels, a back panel, a bottom panel have fastening material thereon which enable the fastening of accessories to the surfaces of said panels.

4. The disaster evacuation cart according to claim 1, wherein any of said two side panels, said back panel, and said bottom panel are constructed with bullet resistant materials.

5. The disaster evacuation cart according to claim 1, wherein said wheels rotatably attached to an axle further includes a modular fixed axle attached to an axle plate.

6. The disaster evacuation cart according to claim 1, wherein said wheels rotatably attached to an axle with said axle attached to a suspension system, further includes a modular articulated sliding trunion suspension system.

7. The disaster evacuation cart according to claim 1, wherein said wherein said wheels rotatably attached to an axle with said axle attached to a suspension system, further includes a modular torsion swing arm drop axle suspension system.

8. The disaster evacuation cart according to claim 1, wherein said extension handles, extendable out from the front and rear of the disaster evacuation cart, when extended support a stretcher, sleeping surface, litter cover and cot cover.

9. The disaster evacuation cart according to claim 1, wherein said means for securing said extension handles includes quick disconnect pins.

10. The disaster evacuation cart according to claim 1, wherein said braking system including hand actuated braking levers further includes removable and relocate able hand actuated braking levers.

11. The disaster evacuation cart according to claim 1, wherein said braking system including hand actuated braking levers further includes a caliper brake having manually operated hand braking levers.

12. The disaster evacuation cart according to claim 1, wherein said braking system including hand actuated braking levers further includes a disc brake having manually operated hand braking levers.

13. The disaster evacuation cart according to claim 1, having a tow bar attached thereto.

14. A method from making a disaster evacuation cart, comprising the steps of:
a) providing a box formed from a tubular framework having two side panels, a back panel, a bottom panel and one or more shelf panels attached thereto;
b) providing wheels removably and rotatably attached to an axle, with said axle attached to a suspension system;
c) providing extension handles, extendable out from the front and rear of the disaster evacuation cart, having means for securing said extension handles in a variety of both forward outward and rearward outward length positions; and
d) providing a braking system including hand actuated braking levers located removably on said extension handles.

15. The method for making a disaster evacuation cart according to claim 14, wherein said one or more shelf panels are position adjustable.

16. The method for making a disaster evacuation cart according to claim 14, wherein said two side panels, a back panel, a bottom panel have fastening material thereon which enable the fastening of accessories to the surfaces of said panels.

17. The method for making a disaster evacuation cart according to claim 14, wherein said any of said two side panels, said back panel, and said bottom panel are constructed with bullet resistant materials.

18. The method for making a disaster evacuation cart according to claim 14, wherein said wheels rotatably attached to an axle further includes a modular fixed axle attached to an axle plate.

19. The method for making a disaster evacuation cart according to claim 14, wherein said wheels rotatably attached to an axle with said axle attached to a suspension system, further includes a modular articulated sliding trunion suspension system.

20. The method for making a disaster evacuation cart according to claim 14, wherein said wheels rotatably attached to an axle with said axle attached to a suspension system, further includes a modular torsion swing arm drop axle suspension system.

21. The disaster evacuation cart according to claim 14, wherein said extension handles, extendable out from the front and rear of the disaster evacuation cart, when extended support a stretcher, sleeping surface, litter cover and cot cover.

22. The method for making a disaster evacuation cart according to claim 14, wherein said means for securing said extension handles includes quick disconnect pins.

23. The method for making a disaster evacuation cart according to claim 14, wherein said braking system including hand actuated braking levers further includes removable and relocate able hand actuated braking levers.

24. The method for making a disaster evacuation cart according to claim 14, when said braking system including hand actuated braking levers further includes a caliper brake having manually operated hand braking levers.

25. The method for making a disaster evacuation cart according to claim 14, wherein said braking system including hand actuated braking levers further includes a disc brake having manually operated hand braking levers.

26. The method for making a disaster evacuation cart according to claim 14, having a tow bar attached thereto.
